(19) United States
(12) Patent Application Publication
(10) Pub. No.: US 2007/0279066 A1
(43) Pub. Date: Dec. 6, 2007

(54) MINIATURIZED BATTERY TESTER

(76) Inventor: STAN CHISM, Odessa, TX (US)

Correspondence Address: WOOD AND EISENBERG, PLLC, 6911 RICHMOND HIGHWAY, SUITE 403, Alexandria, VA, 22306, US

(21) Appl. No.: 11/684,737

(22) Filed: Mar. 12, 2007

Related U.S. Application Data
(60) Provisional application No. 60/803,829, filed on Jun. 2, 2006.
(60) Provisional application No. 60/871,450, filed on Dec. 21, 2006.

(51) Int. Cl. G01N 27/416

(52) U.S. Cl. 324/437

(57) ABSTRACT

A miniaturized battery tester that fits comfortably inside a shirt pocket. In one non-limiting embodiment, the invention comprises: first and second battery-test probes, wherein the first battery-test probe is a retractable battery-test probe; a finger grip member for holding the first battery-test probe; a circuit board, wherein the circuit board includes a battery-test circuit, the battery-test circuit includes a plurality of LEDs for displaying voltage; and a housing. The battery-testing circuit is in operable communication with the first and second battery-test probes. The housing having front and rear surfaces with a voltage display integrated into the front surface, the voltage display comprising the plurality of LEDs. The circuit board is less than about 3 cm in width and less than about 8 cm in length. The miniaturized battery tester is between about 1 oz and about 3 ozs in weight.

### CROSS-REFERENCE TO RELATED APPLICATIONS

This application claims the benefit of priority from U.S. Provisional Patent Application Ser. Nos. 60/803,829 (filed Jun. 2, 2006) and 60/871,450 (filed Dec. 21, 2006). The contents of Provisional Patent Application Ser. Nos. 60/803,829 and 60/871,450 are incorporated herein by reference in their entirety.

### STATEMENT REGARDING FEDERALLY SPONSORED RESEARCH OR DEVELOPMENT

Not Applicable.

### FIELD OF THE INVENTION

This invention relates to battery-testing devices and, more specifically, to a miniaturized battery tester that can be carried in a shirt-pocket.

### BACKGROUND OF THE INVENTION

Chemical storage batteries, such as lead acid batteries used in automobiles, have existed for many years. In order to make optimum use of such a battery, it is very desirable to test the battery to determine its state of health to reduce electrically related car breakdowns. Various techniques have been used to measure battery parameters as described, for example, in U.S. Pat. No. 5,914,605, issued Jun. 22, 1999 to Bertness; the Bertness '605 patent is incorporated herein by reference in its entirety. For example, hygrometers have been used to measure the specific gravity of a battery and voltage measurements have been used to monitor the voltage of the battery.

One battery-testing technique that has been popular for many years is known as a load test in which a battery is heavily loaded over a period of time and the decay in the battery output is monitored. However, such a test is time consuming and leaves the battery in a relatively discharged condition. Further, such a tester must be made relatively large if it is to be used with large batteries. Thus, there is a need for a battery tester that is not large or cumbersome to use.

Car owners rarely carry a battery tester. Car owners often forget to check or otherwise find it difficult to check the status of their car's battery. Vehicle breakdowns due to battery failure are sadly quite common, particular with regard to older vehicles with batteries that are several years old. Vehicles operated under harsh conditions often place a heavier burden on car batteries. Vehicle owners in Alaska often drive in poor light conditions that result in greater continuous loads on vehicle batteries. Thus, there is a need for battery tester designed for ease of use and which a vehicle owner can easily carry.

In addition, house owners and property renters often make use of batteries around the home to power electrical items. For example, every householder is encouraged by FEMA (Federal Emergency Management Agency) to have a battery-powered radio, a flashlight and spare batteries. Batteries for emergency use are frequently stored for long periods of time without use. The voltage range of the batteries can include one or more batteries arranged in series or single 6 volt batteries. Thus, there is a need for a battery tester that can be used by a non-expert householder to check on the status of 12 and 6-volt batteries.

### SUMMARY OF THE INVENTION

A miniaturized battery tester that fits comfortably inside a shirt pocket. In one non-limiting embodiment, the invention comprises: first and second battery-test probes, wherein the first battery-test probe is a retractable battery-test probe; a finger grip member for holding the first battery-test probe; a circuit board, wherein the circuit board includes a battery-test circuit, the battery-test circuit includes a plurality of LEDs for displaying voltage; and a housing. The battery-testing circuit is in operable communication with the first and second battery-test probes. The housing having front and rear surfaces with a voltage display integrated into the front surface, the voltage display comprising the plurality of LEDs. The circuit board is less than about 3 cm in width and less than about 8 cm in length. The miniaturized battery tester is between about 1 oz and about 3 ozs in weight.

### BRIEF DESCRIPTION OF THE DRAWINGS

FIG. 1A shows an environmental perspective view of a miniaturized battery tester according to the present invention.

FIG. 1B shows an environmental perspective view of a miniaturized battery tester according to the present invention.

FIG. 2 shows a top view of the miniaturized battery tester of FIG. 1A.

FIG. 3 shows a bottom view of the miniaturized battery tester of FIG. 1A.

FIGS. 4A and 4B are perspective top views of the miniaturized battery tester of FIG. 1A.

FIGS. 4A and 4B are perspective top views of the miniaturized battery tester of FIG. 1A.

FIGS. 5A and 5B are perspective bottom views of the miniaturized battery tester of FIG. 1A.

FIG. 6 shows a bottom view of the miniaturized battery according to the present invention.

FIG. 7 shows an exploded view of the miniaturized battery tester of FIG. 1A.

FIG. 8 shows a non-limiting exemplar circuit diagram according to the present invention.

FIG. 8A shows a Venn block diagram of a circuit according to one embodiment of the present invention.

### DETAILED DESCRIPTION OF THE INVENTION

This invention is directed to battery-testing devices and, more specifically, to a miniaturized battery tester that can be carried in a shirt-pocket. The miniaturized battery tester of the present invention is denoted generally by the numeric label “100”.

Referring to the FIGURES in general, the miniaturized battery tester 100 is designed to fit comfortably inside a shirt pocket and weighs between about 1 oz and about 3 ozs (i.e., between about 1 ounce and about 3 ounces in weight). The Applicant has built a version that weighs about 1.4 ozs in weight (i.e., about 1.4 ounces in weight).

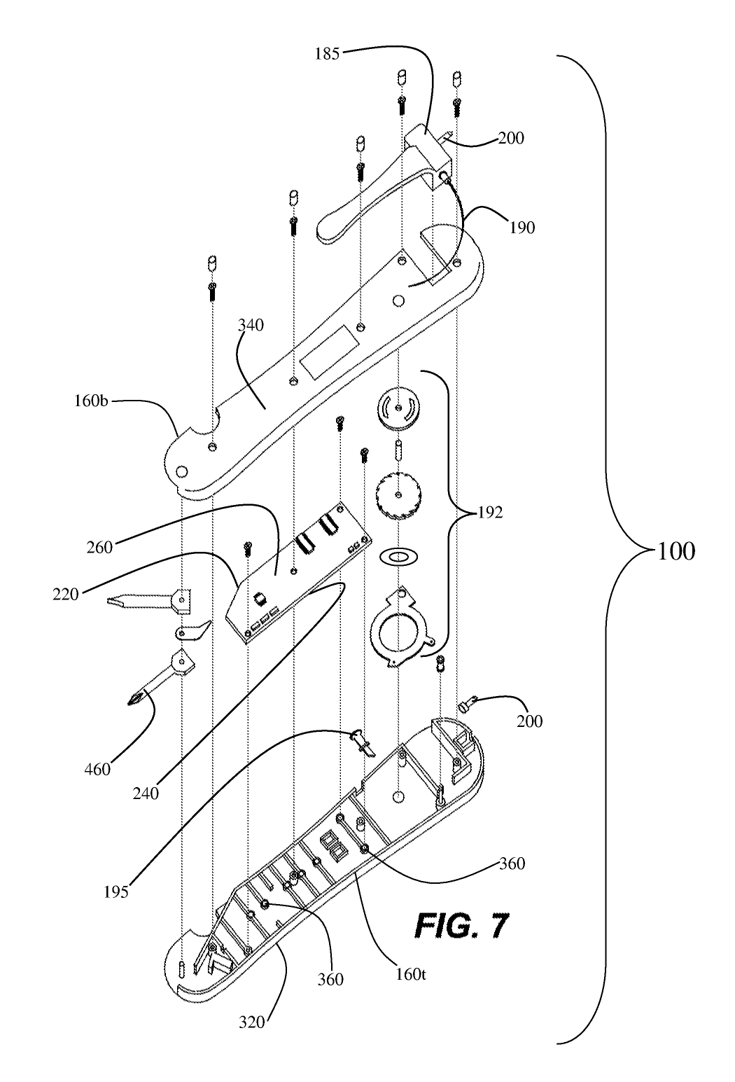

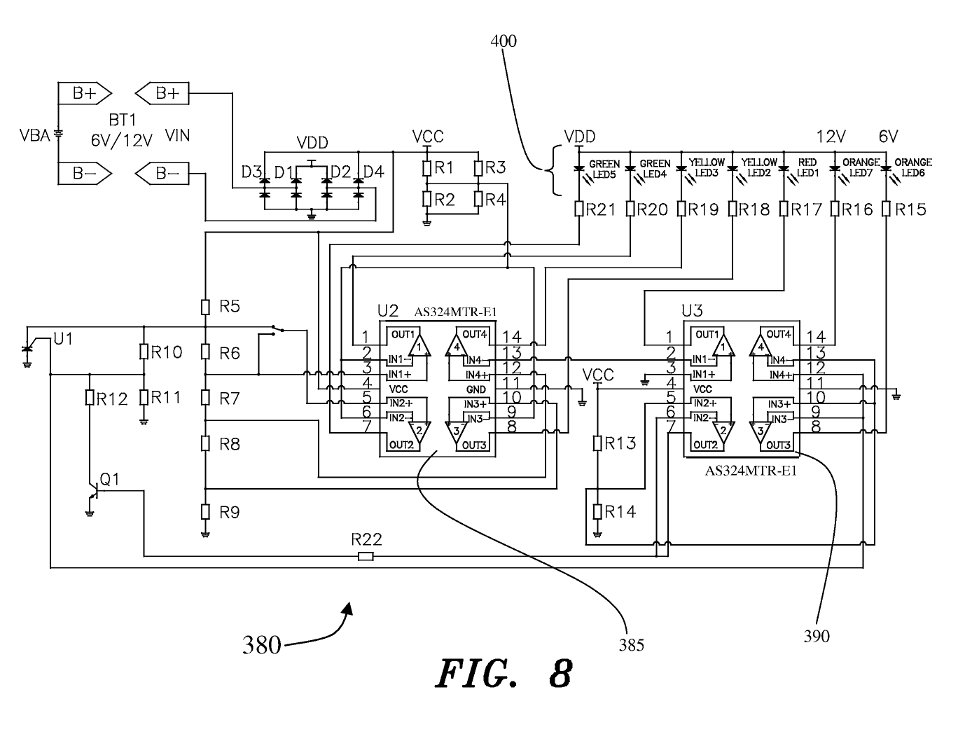

The miniaturized battery tester 100 comprises: housing 160, first 180 and second 200 battery-test probes, and a circuit board 220. The housing 160 has opposite ends 280 and 300, and front and rear surfaces 320 and 340, respectively. The front surface 320 includes a plurality of apertures 360 (shown in FIG. 7). In one embodiment, the circuit board 220 is a double-sided circuit board having opposite sides 240 and 260.

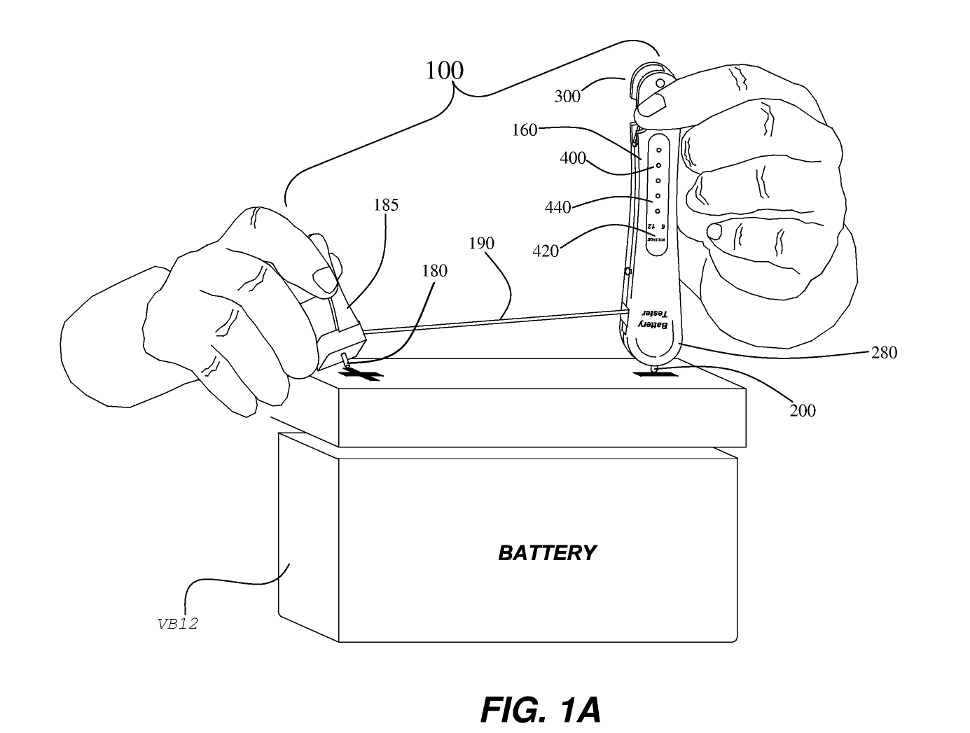

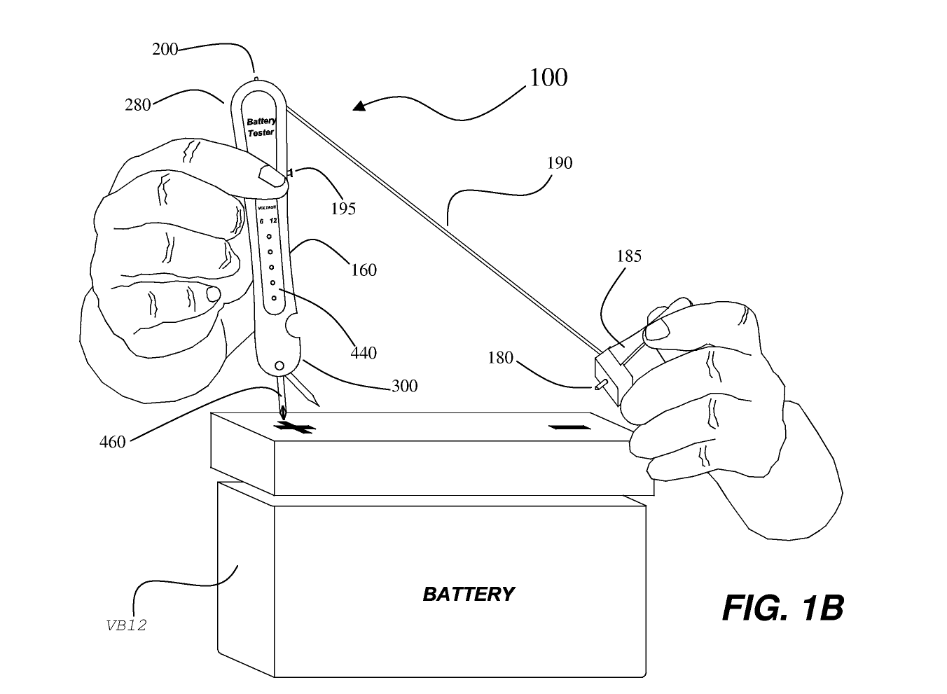

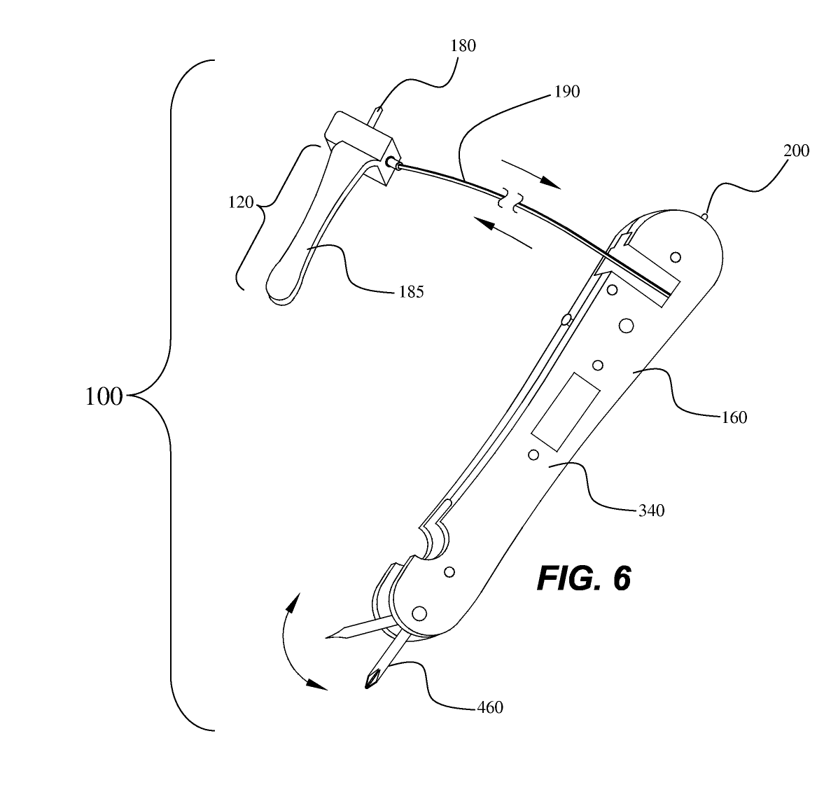

Still referring to the FIGURES in general, the first battery-test probe 180 is retractable, wherein the probe 180 can be pulled away from, and returned to, the housing 160. The probe 180 is connected to a retractable wire 190. A finger grip member 185 is used to hold the first battery-test probe 180 as shown, for example, in FIG. 1A. In one embodiment the finger grip member 185 serves acts as a finger grip to hold first battery-test probe 180, wherein the finger grip member 185 is shaped in part as a shirt pocket clip 120 (see, for example, FIG. 6). Thus, the finger grip member 185 can optionally serve a dual purpose.

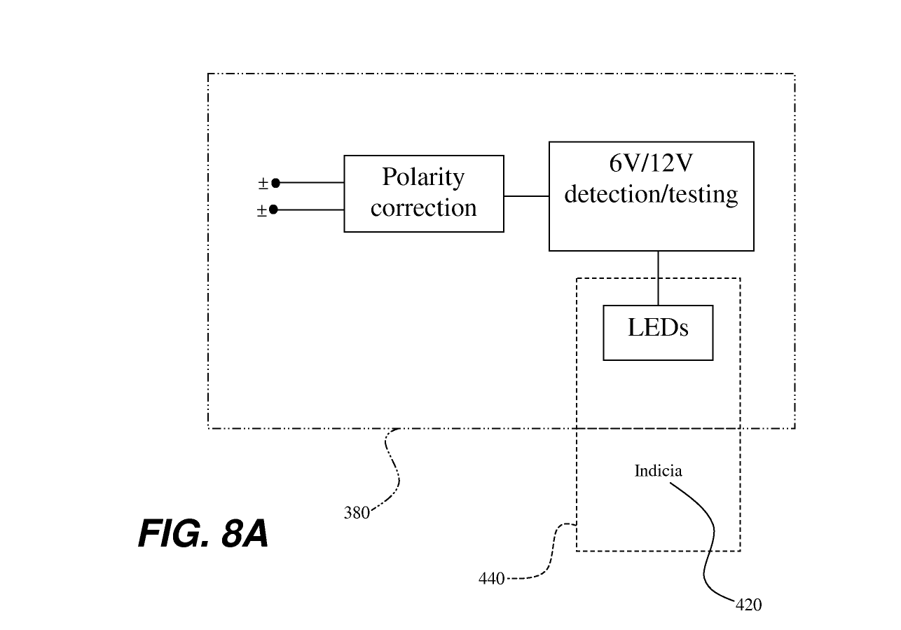

The circuit board 220 is located in housing 160 and includes a battery-testing circuit 380, an exemplar of which is shown in FIG. 8. The battery-testing circuit 380 is in operable communication with first and second battery-test probes 180 and 200 and includes an array of light emitting diodes (LEDs) 400. The array of LEDs 400 is arranged on opposite side 240 of the circuit board 220. The array of LEDs 400 is disposed through apertures 360 and hence visible on the front surface 320 of housing 160. Suitable indicia 420 are disposed on the front surface 320, which in combination with the array of LEDs 400 provide a visual voltage display 440. It should be understood that the term “suitable indicia” is intended to mean any suitable words in any language known to mankind that indicate to an ordinary user of the device 100 that what they are looking at is a voltage display 440.

Referring specifically to the FIGURES of which FIG. 1A shows a perspective environmental view of the miniaturized battery tester 100 according to the present invention. The miniaturized battery tester 100 is shown being used to test the voltage of a 12 Volt vehicle battery VB12; however, the miniaturized battery tester 100 can also be used to test a 6 Volt battery. More specifically, the circuit 380 is designed to test both 6 and 12 Volt batteries. The voltage display 440 can provide information on the state of what are commonly referred to as 6 Volt and 12 Volt batteries. More specifically, the circuit 380 (see FIG. 8) has a voltage range of about 5.8V to about 6.4V and between about 11.5V to about 12.8V. However, any suitable circuit can be used and circuit 380 is a non-limiting example of a suitable circuit.

Still referring to FIG. 1A, the first battery testing probe 180 is shown extended from the housing 160 (also see FIG. 6) to make contact with the positive terminal of the 12 Volt vehicle battery VB12, and the second battery testing probe 200 is shown touching or otherwise making contact with the negative terminal of vehicle battery VB12.

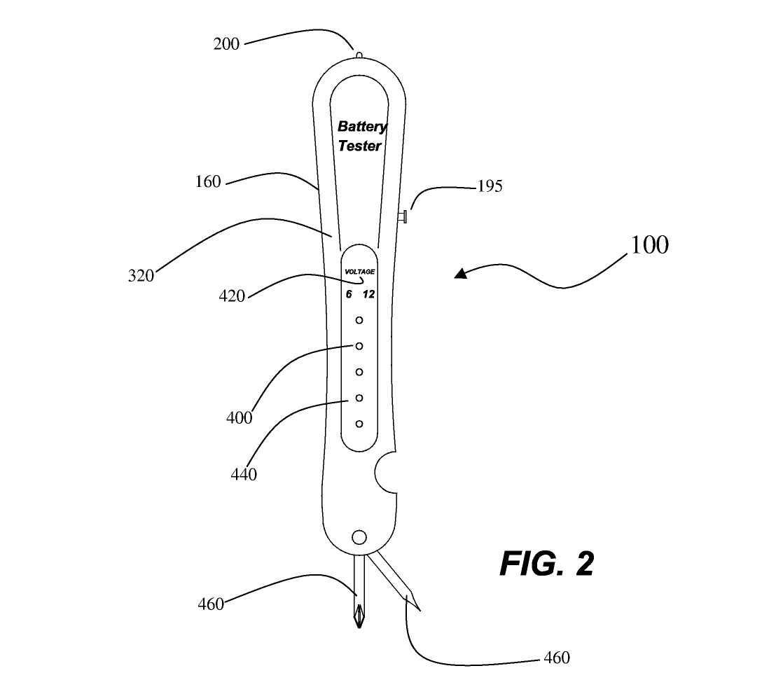

The design of battery testing circuit 380 (a non-limiting exemplar of which is shown in FIG. 8) is such that the first and second probes 180 and 200 can be connected to either terminal of a battery and the voltage displayed on voltage display 440 (also see FIG. 8A). For example, the first probe 180 can be connected to the negative terminal of vehicle battery VB12, and second probe 200 connected to the positive terminal of vehicle battery VB12. It should be understood that the particular arrangement of LEDs 400 can be arranged in any suitable manner for displaying voltage and is not limited to the arrangement shown, for example, in FIG. 2.

Referring to FIG. 1B, which shows an embodiment of the miniaturized battery tester 100 in which one or more optional screw bits 460 are shown attached to housing end 300, and second battery-test probe 200 is shown attached to the other housing end 280. The optional screw bits 460 are preferably operably connected to circuit 380. Thus a battery, such as exemplar 12 Volt battery VB12, can be tested as shown in FIG. 1B using the first battery-test probe 180 and one of the optional screw bits 460. A release member 195 can be used to control the extension and return of retractable wire 190.

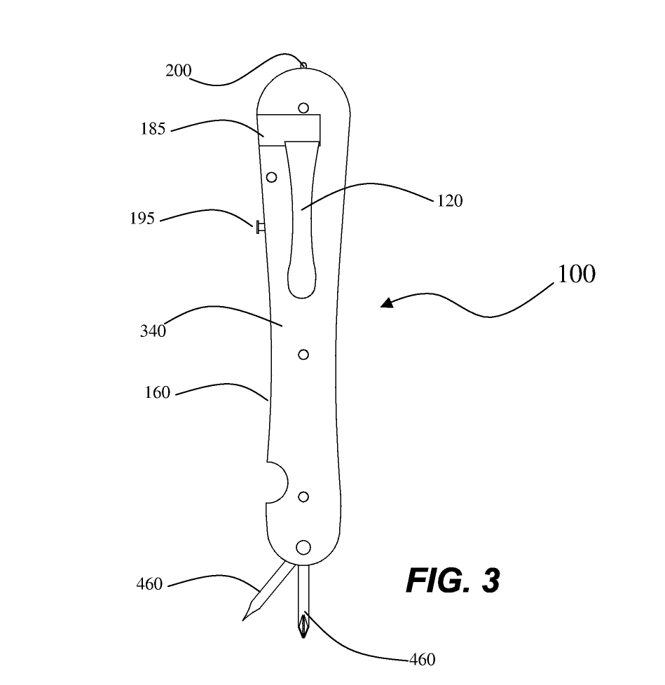

FIGS. 2 and 3 respectively show front and rear planar views of the miniaturized battery tester 100.

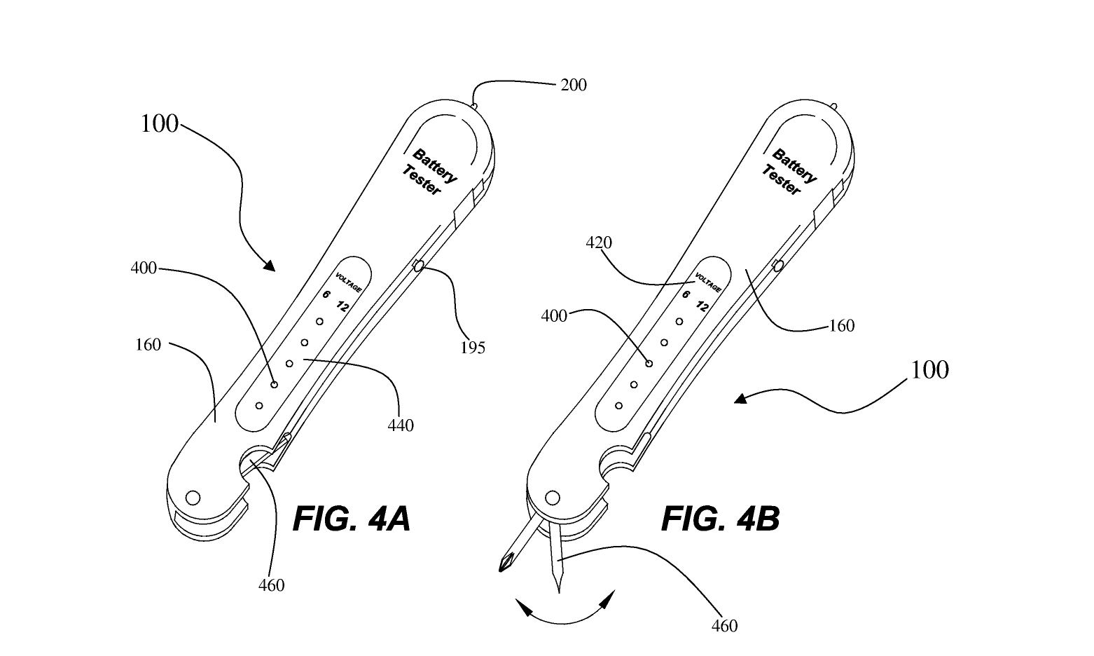

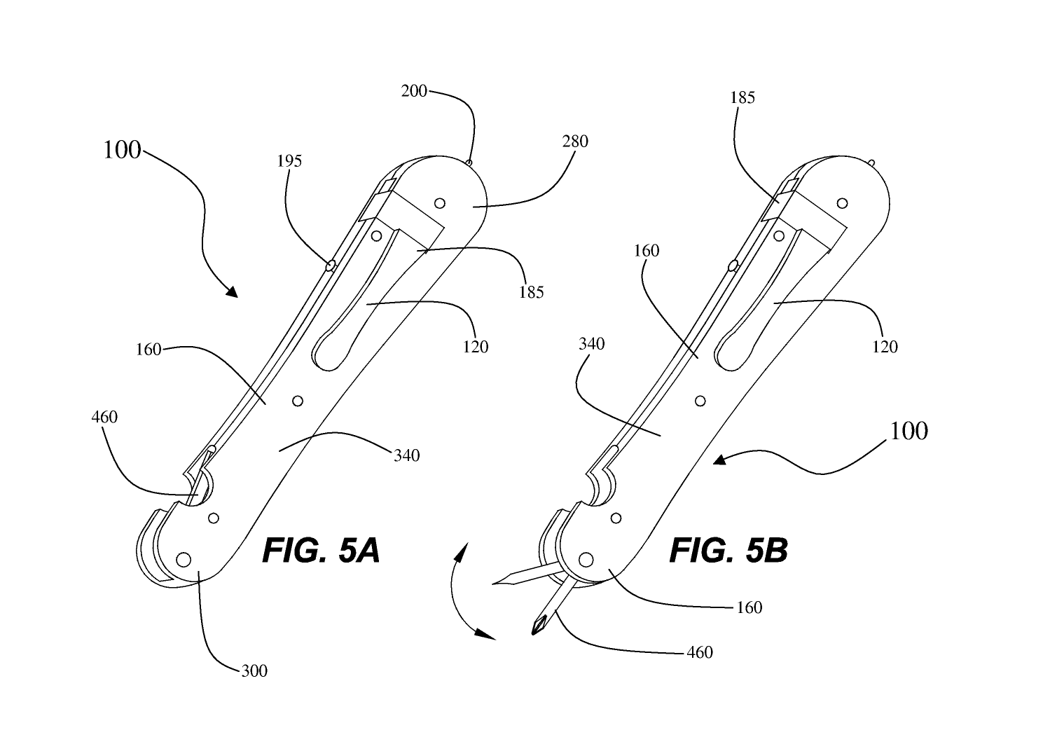

It should be understood that any suitable location can be used for the location of, for example, second battery-test probe 200 and/or optional screw bits 460 and is expressly not limited to housing ends 280 and 300, respectively. Optional screw bits 460 are shown in FIGS. 4A, 4B, 5A, 5B and 6. The optional screw bits 460 can be rotated by a person's fingers from the housing 160 as illustrated in FIGS. 4A, 4B, 5A, 5B and 6. The finger grip member 185 can also be shaped to also function as a shirt-pocket clip (represented by numeric label “120” in, for example, FIG. 6).

FIG. 7 shows an exploded view of the miniaturized battery tester 100. The miniaturized battery tester 100 includes a wire retractable wire mechanism 192 that allows the retractable wire 190 to wind out and return to the housing 160. The housing 160 is shown in two halves made up of a bottom half and a top half respectively represented by alphanumeric labels “160b” and “160t”. The two halves are typically joined together in the manufacturing process to produce complete housing 160. The housing 160 can be made out of any suitable material such as, but expressly not limited to, an injection moldable plastic polymer.

FIG. 8 shows one embodiment of the battery testing circuit 380. It will be understood by persons with ordinary skill in the art that any suitable battery testing circuit can be used in place of the illustrated circuit 380 without detracting from the spirit of the invention.

Still referring to FIG. 8, the battery-testing circuit 380 features first 385 and second 390 integrated circuit (IC) chips. Each of the integrated circuit chips 385 and second 390 include four independent operational amplifiers. The IC chips 385 and second 390 can be any suitable IC chip such as the AS324 IC chip, which in turn can be the AS324MTR-E1 version of the AS324 IC chip. The IC chips 385 and second 390 enable the battery testing circuit 380 to be miniaturized and in turn reduce the size and space occupied by the circuit board 220 thus enabling the circuit board 220 to have a width between about 1 cm and about 3 cm, and a length between about 5 cm and about 10 cm. In one embodiment, the circuit board 220 has a width between about 2 cm and about 3 cm, and a length between about 5 cm and about 8 cm. In yet another embodiment, the circuit board 220 has a width of about 2.5 cm and a length of about 8 cm.

In one non-limiting embodiment, the circuit board 220 is less than about 3 cm in width and less than about 8 cm in length.

In another non-limiting embodiment, the circuit board 220 is less than about 2.5 cm in width and less than about 6.5 cm in length.

In another non-limiting embodiment, the housing has a generally elongated shape, less than about 4 cm wide, less than about 20 cm long, and less than about 2.5 cm in depth.

In another embodiment, the housing is about 3 cm wide, 15 cm long, and about 1.5 cm in depth.

In another embodiment, the housing comprises an oval cross-section shape having a diameter of less than about 10 cm and a width or thickness of less than about 4 cm.

In another embodiment, the housing comprises an oval cross-section shape having a diameter of less than about 8 cm and a width or thickness of less than about 3 cm.

In another embodiment, the housing comprises an oval cross-section shape having a diameter of less than about 7 cm and a width or thickness of less than about 2 cm.

The weight of the miniaturized battery tester 100 is between about 1 oz (i.e., one ounce in weight) and about 5 ozs (i.e., five ounces in weight). In one embodiment, the battery tester 100 is between about 1 oz and about 3 ozs in weight. In one embodiment, the battery tester 100 is between about 1 oz and about 2 ozs in weight. In one embodiment, the battery tester 100 is about 1.5 ozs in weight. In one embodiment, the battery tester 100 is 1.4 ozs in weight (to one decimal place).

It should be understood that the housing is not limited to a particular shape. For example, the housing can have a least one shape selected from the group consisting of: a regular polygonal shape, an irregular polygonal shape, a rectangular, square, and an oval shape. The only limitation on the housing is that the housing is sufficiently small to be carried in a pocket such as a shirt pocket.

In yet another embodiment, the voltage display includes at least one LED, which lights up if the battery being tested has a voltage of about 6V and at least one other LED, which lights up if the battery has a voltage of about 12V.

The attached drawings show a non-limiting exemplary example of the miniaturized battery tester according to the present invention.

It is to be understood that the present invention is not limited to the specific embodiments described above, but encompasses any and all embodiments within the scope of the following claims.

I claim:

1. A miniaturized battery tester that fits comfortably inside a shirt pocket, comprising:
first and second battery-test probes, wherein said first battery-test probe is a retractable battery-test probe;
a finger grip member for holding said first battery-test probe;
a circuit board, wherein said circuit board includes a battery-test circuit, said battery-test circuit includes a plurality of LEDs for displaying voltage, wherein said battery-testing circuit is in operable communication with said first and second battery-test probes; and
a housing, wherein said circuit board is located in said housing, said housing having front and rear surfaces with a voltage display integrated into said front surface, said voltage display comprising said plurality of LEDs,
wherein said circuit board is less than about 3 cm in width and less than about 8 cm in length, and
wherein said miniaturized battery tester is between about 1 oz and about 3 ozs in weight.

2. The miniaturized battery tester according to claim 1, wherein said finger grip member is fashioned into a shirt pocket clip.

3. The miniaturized battery tester according to claim 1, wherein said voltage display further comprises a plurality of apertures aligned with said LEDs, and a transparent cover over said plurality of apertures such that said LEDs are visible to a user operating said miniaturized battery tester.

4. The miniaturized battery tester according to claim 1, wherein said circuit board has a width between about 1 cm and about 3 cm, and a length between about 5 cm and about 10 cm.

5. The miniaturized battery tester according to claim 1, wherein said circuit board has a width of about 2.5 cm and a length of about 8 cm.

6. The miniaturized battery tester according to claim 1, wherein said housing is less than about 4 cm wide, less than about 20 cm long, and less than about 2.5 cm in depth.

7. The miniaturized battery tester according to claim 1, wherein said housing is about 3 cm wide, 15 cm long, and about 1.5 cm in depth.
